(19) United States
(12) Patent Application Publication
(10) Pub. No.: US 2013/0103418 A1
(43) Pub. Date: Apr. 25, 2013

(54) PATIENT IDENTIFICATION

(71) Applicants: Bryan Dove, Seattle, WA (US); Michael J. Bortnick, Oswego, IL (US)

(72) Inventors: Bryan Dove, Seattle, WA (US); Michael J. Bortnick, Oswego, IL (US)

(73) Assignee: MICROSOFT CORPORATION, Redmond, WA (US)

(21) Appl. No.: 13/276,335

(22) Filed: Oct. 19, 2011

(51) Int. Cl. G06Q 50/24

(52) U.S. Cl. 705/3

(57) ABSTRACT

The description relates to patient identification and consent. One example can determine that a patient possessing a mobile computing device is at a location associated with a health care provider. This example can request consent from the patient via the mobile computing device for the health care provider to access the patient's health care records.

### BACKGROUND

Patient identity is a complex problem that only continues to grow as patients interact with a wider variety of health care providers in a wider array of settings. Presently when a person or patient interacts with a health care system, textual or structured data, such as social security number, date of birth, gender, etc., is obtained from the person. A health care staff member then uses this data to identify a corresponding patient in the system. This process is rife with errors. The process is compounded when the patient goes to a different health care system and attempts are made to correlate identities across or between systems.

### SUMMARY

The description relates to patient identification and consent and utilizing a mobile computing device belonging to the patient in the patient identification and/or consent. One example can determine that a patient possessing a mobile computing device is at a location associated with a health care provider. This example can request consent from the patient via the mobile computing device for the health care provider to access the patient's health care records.

In another example a presence of a patient that has a mobile computing device can be detected at a health care facility. The mobile computing device can be utilized to obtain consent from the patient for the health care facility to access health care records of the patient.

The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIG. 1 shows an example of a scenario in which the patient identification concepts can be employed in accordance with some implementations of the present concepts.

FIG. 2 shows an example of a mobile computing device upon which patient identification can be performed in accordance with some implementations of the present concepts.

FIG. 3 shows an example of a health care records management system in accordance with some implementations of the present concepts.

FIGS. 4-5 illustrate examples of flowcharts of patient identification methods in accordance with some implementations of the present concepts.

### DETAILED DESCRIPTION

### Overview

This patent relates to patient identification and patient consent in a health care setting. The present concepts can leverage a mobile computing device belonging to the patient to identify (or help identify) the patient. Further, the concepts can utilize the mobile computing device to obtain consent from the patient to allow a health care facility or health care provider to access patient health records.

### Scenario Example

The discussion above broadly introduces patient identification and consent concepts. To aid the reader in understanding these concepts, scenario 100 provides a tangible example to which the concepts can be applied. Scenario 100 involves instances 1 and 2, each of which is discussed below. Starting at instance 1, example scenario 100 involves a patient 102 that presents for care at hypothetical health care provider ABC (e.g., provider geographical location designated generally at 104), such as in an emergency room. In this case, the patient has a mobile device or mobile computing device (MCD) 106. A caregiver 108 may obtain information from the patient and input the information into a patient database via notebook computer 110. The information may be used to determine if the patient matches a patient (e.g., patient identification) in the patient database or to create a new patient identification in the patient database.

The mobile computing device 106 can be utilized in various ways to contribute to determining that the patient is at the provider location 104. For instance, the patient 102 may have a health care application running on the mobile computing device 106. With the user's permission, the health care application may track user location (e.g., the geographical location of the mobile computing device) and automatically determine when the user is at a health care facility. For instance the application may cross-reference or map the mobile computing device location with locations of health care facilities.

Stated another way, through some combination of information obtained from the patient 102 and/or other information obtained from the mobile computing device 106, the presence of the patient at the provider location 104 can be detected. For example, in one case, the caregiver 108 can obtain the patient's name and mobile computing device telephone number and/or email address. Assume for purposes of example that the patient gives her name as “Jane Doe” and mobile computing device telephone number 999-999-9999. The caregiver can enter this information into the patient database via notebook computer 110.

At instance 2, the patient 102 can utilize the mobile computing device 106 to give consent for the health care facility to access health care records of the patient. For instance, continuing with the previous example, the patient information can be utilized to cause a consent to be generated on the mobile computing device. In one such case, the information can be utilized to contact the patient via the mobile computing device. For instance, a text message can be sent to the telephone number of the mobile computing device. The text message could directly request consent or could include a link that when accessed by the patient, presents the consent request. The patient can then accept or reject the consent request. For example, instance 2 shows a consent request graphical user interface (GUI) 112. This graphical user interface states “Jane Doe—You are at health care provider ABC, which would like to access your patient information records.” The user can consent at 114, or refuse or reject the consent at 116.

In some cases, the consent request may include some type of verification element. The function of the verification element is to reduce or avoid misidentification of the patient. For instance in an alternative to the illustrated example, the user interface may state “If you consent to sharing your patient records with health care provider ABC please enter the last four digits of your social security number.” Of course, a variety of verification elements can be implemented.

In summary, the presence of patient 102 who has a mobile computing device 106 can be detected at a health care facility (e.g., provider location 104). The mobile computing device 106 can be utilized to obtain consent from the patient 102 for the health care facility (e.g., provider location 104) to access health care records of the patient 102.

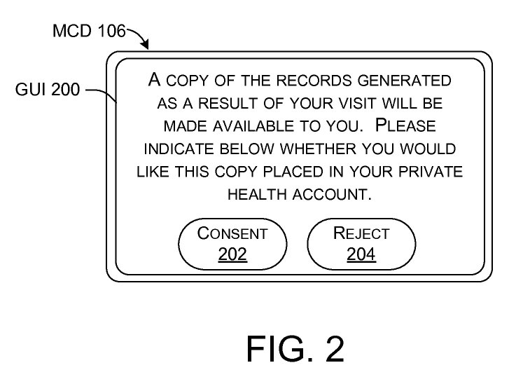

Mobile computing device 106 can also be leveraged to facilitate other aspects of the patient-provider relationship. For instance, in some existing scenarios, the health care facility may give a copy of any patient records generated during the visit to the patient. Patients tend to be overwhelmed with managing these records. The present concepts can allow the mobile computing device to be leveraged so that an electronic copy of the records can be made available to the patient instead of the physical records. For instance, FIG. 2 shows a GUI 200 that can be presented on mobile computing device 106 for the patient. GUI 200 states that “A copy of the records generated as a result of your visit will be made available to you. Please indicate below whether you would like this copy placed in your private health account.” The patient can then consent at 202 or reject at 204. Thought not shown, some implementations may allow the user to specify another place where the electronic copy can be placed.

Placing an electronic copy of the patient records in the patient's private health account (or similar location) can be advantageous for the health care provider in that it is simpler and requires less worker time than providing a physical copy to the patient. Placing an electronic copy of the patient records in the patient's private health account (or similar location) can be advantageous for the patient in that he/she does not need to carry and/or manage the records and/or worry about losing them. Further, there is a much greater likelihood that the next health care provider can obtain the records from the private health account rather than relying on the patient to bring the copy.

In some cases, the health care provider may manage their own patient records. In other cases, the health care provider may engage a health care record management service to manage their patient records. The patient's private health account may be managed by the health care record management service that manages patient records for the health care facility or the patient's private health care account may be managed by a different health care record management service.

### System Example

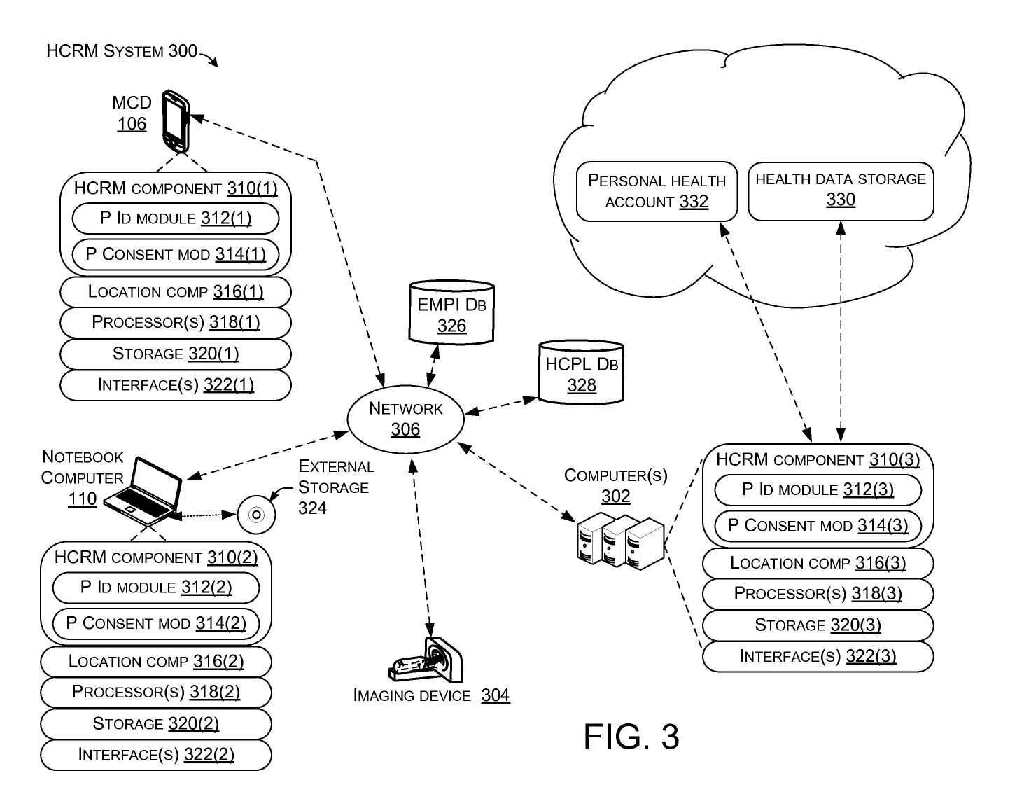

FIG. 3 shows an example of a health care record management system (HCRM system) 300. Example HCRM system 300 can include one or more computers or computing devices. In this case, HCRM system 300 includes mobile computing device 106, notebook computer 110, and computer(s) 302. In this example, HCRM system 300 also includes an imaging device 304, which may or may not be a computing device. HCRM system 300 can also include at least one network 306. The network allows communication between mobile computing device 106, notebook computer 110, computer(s) 302, and imaging device 304. For sake of brevity, only a single network is illustrated, but several networks may be utilized in some implementations. For instance, notebook computer 110, imaging device 304 and computer(s) 302 can communicate over the Internet, while computer(s) 302 can communicate with mobile computing device 106 via a cellular network.

In this configuration, mobile computing device 106, notebook computer 110, and computer(s) 302 can include a health care records management (HCRM) component 310. In this description, the suffixes “(1)”, “(2)”, and “(3)” are used to distinguish between the HCRM components on the mobile computer device 106, notebook computer 110, and computer(s) 302, respectively. Reference to HCRM component 310 without a suffix is generic to the various HCRM components. In this case, the HCRM component 310 can include a patient identification (P ID) module 312, a patient consent (P consent) module 314, and a location component 316. Mobile computing device 106, notebook computer 110, and computer(s) 302 can also include a processor(s) 318, storage 320, and an interface(s) 322.

Further, the HCRM system can include external storage 324, an electronic master patient index (EMPI) database 326, a health care provider location (HCPL) database 328, health data storage 330 and/or a personal health account 332.

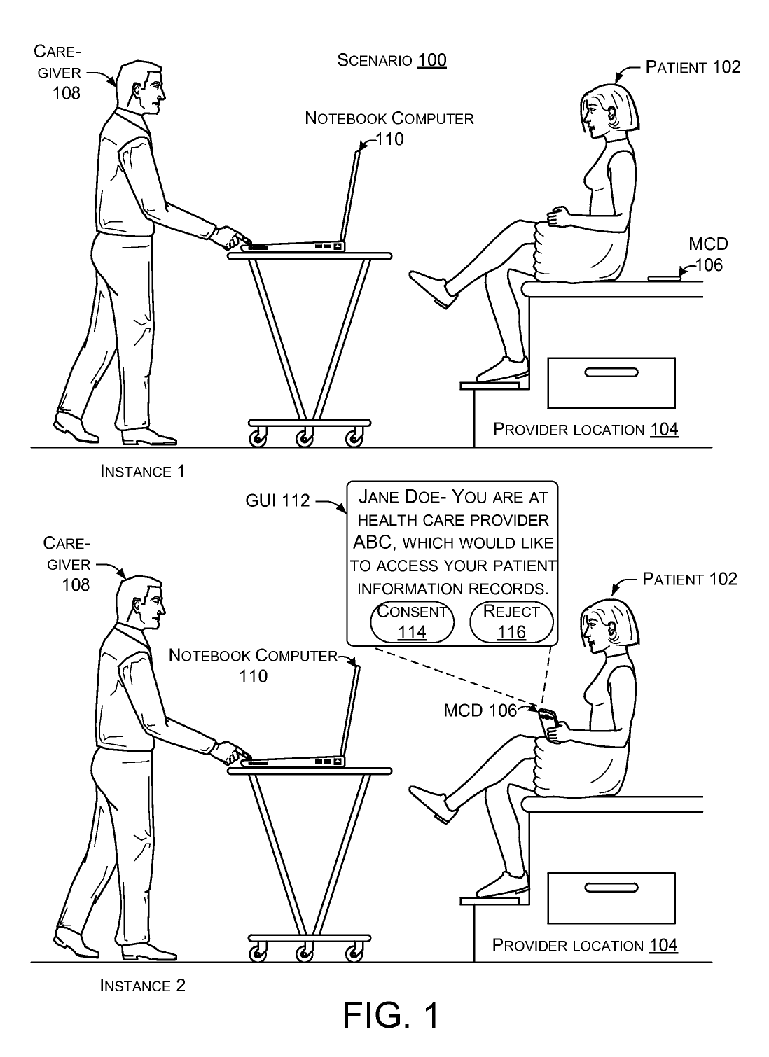

As introduced above relative to FIG. 1, an identity of the patient can be determined through entry of information on notebook computer 110 and/or by obtaining information from mobile computing device 106. In HCRM system 300, the patient identification module 312 can contribute to this function. In one implementation the patient identification module 312 can recognize the patient identity by detecting the telephone number of the mobile computing device and then cross referencing the telephone number with other records. For instance, the patient identification module 312 can compare the mobile computing device telephone number to telephone numbers in the EMPI database 326. EMPI database 326 can include and/or reference patient files. Each patient file can be associated with a unique identifier or patient identifier and can include the records of that patient. A match to a file in the EMPI database can indicate the patient's identity (e.g. unique patient ID). The unique patient ID can be utilized to access the patient's records from the health data storage 330.

In other implementations, the patient identification module 312 can compare the telephone number with other sources. The sources for these correlations can come from telephone company records (e.g., called ID, billing records), credit reports, insurance eligibility checks, or others. In still other implementations, the patient identification module 312 can leverage other accounts on the mobile computing device. For instance, if the user is logged in as a specific user on an application, such as a social media site, on the mobile computing device the patient identification module 312 can use that information to determine the identity of the patient.

In some implementations, the patient identification module 312 can cause a determined identity to be verified by the patient. For instance, the patient can be prompted on the mobile computing device to confirm their identity by providing a challenge piece of information based upon the source of the identity correlated with their mobile computing device. For example, the patient identification module can ask the patient the last four digits of their social security number, or billing address for telephone company records, among others.

In other implementations, the verification can come from location information obtained from the mobile computing device 106. For instance, if hypothetical health care provider ABC obtains the patient's name and mobile computing device phone number and the location of the patient's mobile computing device is at the location of health care provider ABC, this location information can confirm that the patient has not been misidentified. In some cases, the patient identification module 312 can communicate with the location component 316 to obtain the location information of the mobile computing device 106.

The location component 316 can utilize various technologies to determine the location of the mobile computing device. For instance, the location component can obtain and utilize global positioning coordinates (GPS) to determine location. In other cases, when the mobile computing device 106 is utilizing Wi-Fi technologies, the current internet protocol (IP) address can be utilized to determine location. These location technologies may be combined and/or other location technologies can be utilized. In some cases, the location component may include elements which actually measure the location. For instance, on the mobile computing device 106, the location component 316(1) may include circuitry for determining GPS coordinates. In other cases, the location component may log the location information. For instance, location component 316(3) may track the IP addresses utilized by the mobile computing device to determine location. In other cases, location can be determined based upon triangulation of cell towers with which the mobile computing device is communicating.

The patient consent module 314 can function to obtain consent from the identified patient. In some implementations, the consent can be location centric. For instance, the location of the mobile computing device, as obtained from the location component 316, can be cross-referenced against physical locations of health care providers, such as may be available in the health care provider location (HCPL) database 328. The patient consent module 314 can cross-reference the location of the mobile computing device to the entries in the HCPL database 328 to obtain a list of matches (or near matches). If there are multiple matches the patient consent module can cause a GUI to be generated with the list of matching health care providers. The patient can select which provider(s) from the list the patient consents to allow access (e.g., sharing). The patient consent module can cause a record of the patient's consent to be sent to the selected health care provider and to the patient's personal health account 332. The patient's records in the health data storage 330 can then be made available to the selected health care provider.

In summary, the patient consent module 314 can directly prompt the patient to grant consent to the health care provider by auto-suggesting the health care provider based upon IP and/or GPS association.

Patient records generated during the visit can be stored in health data storage 330 and/or in a personal health account 332 associated with the patient. For instance, an image, such as a CT scan or an MRI of the patient can be communicated from imaging device 304 to computer(s) 302 for storage in health data storage 330 and/or in a personal health account 332. Similarly, other records, such as notes from the treating physician can be communicated from notebook computer 110 to computer(s) 302 for similar treatment. The patient identification module 312 and/or the patient consent module 314 can cause a notification to be presented on the mobile computing device 106 that summarizes for the patient where the patient records are stored.

Processor 318 can execute data in the form of computer-readable instructions to provide a functionality. Data, such as computer-readable instructions, can be stored on storage 320. The storage can include any one or more of volatile or non-volatile memory, hard drives, and/or optical storage devices (e.g., CDs, DVDs etc.), among others. As used herein, the term “computer-readable media” can include transitory and non-transitory computer-readable instructions. In contrast, the term “computer-readable storage media” (e.g., storage 320) excludes transitory instances. Computer-readable storage media includes “computer-readable storage devices”. Examples of computer-readable storage devices include volatile storage media, such as RAM, and non-volatile storage media, such as hard drives, optical discs, and flash memory, among others.

Any of mobile computing device 106, notebook computer 110, and/or computer 302 can also be configured to receive and/or generate data in the form of computer-readable instructions from external storage 324. Examples of external storage 324 can include optical storage devices (e.g., CDs, DVDs etc.), hard drives, and flash storage devices (e.g., memory sticks or memory cards), among others. In some cases, HCRM component 310 can be installed on the computing device during assembly or at least prior to delivery to the consumer. In other scenarios, HCRM component 310 can be installed by the consumer, such as in the form of a download available over network 306 and/or from external storage 324.

The HCRM component 310 can be manifest as a freestanding application or as an application part, among other examples. In HCRM system 300, each of mobile computing device 106, notebook computer 110, and computer 302 are illustrated with a full feature HCRM component 310. However, other implementations may utilize other configurations with little or no processing performed at the mobile computing device 106 and/or configurations where the processing is distributed over multiple distributed computers and/or the processing is performed in the cloud. In one such example, the mobile computing device 106 can access a web-site maintained by computer 302. The majority of the processing associated with the HCRM component can be performed and/or coordinated by computer 302. The result of this processing can be displayed as a GUI on mobile computing device 106 so that the patient can interact with the mobile computing device. Any patient input can be communicated from the mobile computing device back to computer 302 for further processing.

The term “computer” or “computing device” as used herein can mean any type of device that has some amount of processing capability. Examples of computing devices can include traditional computing devices, such as personal computers, cell phones, smart phones, personal digital assistants, pad-type computers, or any of a myriad of ever-evolving or yet to be developed types of computing devices. Further, a HCRM system can be manifest on a single computing device or distributed over multiple computing devices. In various implementations, HCRM component 310 can be implemented as software, hardware, and/or firmware, or in another manner.

In some variations of the illustrated HCRM system 300, each of mobile computing device 106, notebook computer 110 and computer 302 is configured with a general purpose processor 318 and storage 320. In other variations, one or more of the computing devices can include a system on a chip (SOC) type design. In such a case, functionality provided by the HCRM component 310 can be integrated on a single SOC or multiple coupled SOCs. In one such example, the computing device can include shared resources and dedicated resources. An interface(s) can facilitate communication between the shared resources and the dedicated resources. As the name implies, dedicated resources can be thought of as including individual portions that are dedicated to achieving specific functionalities. For instance, in this example, the dedicated resources can include HCRM component 310.

Shared resources can be storage, processing units, etc. that can be used by multiple functionalities. In this example, the shared resources can include the processor. As mentioned above, in one case, HCRM component 310 can be implemented as dedicated resources. In other configurations, this component can be implemented on the shared resources and/or the processor can be implemented on the dedicated resources.

### Method Examples

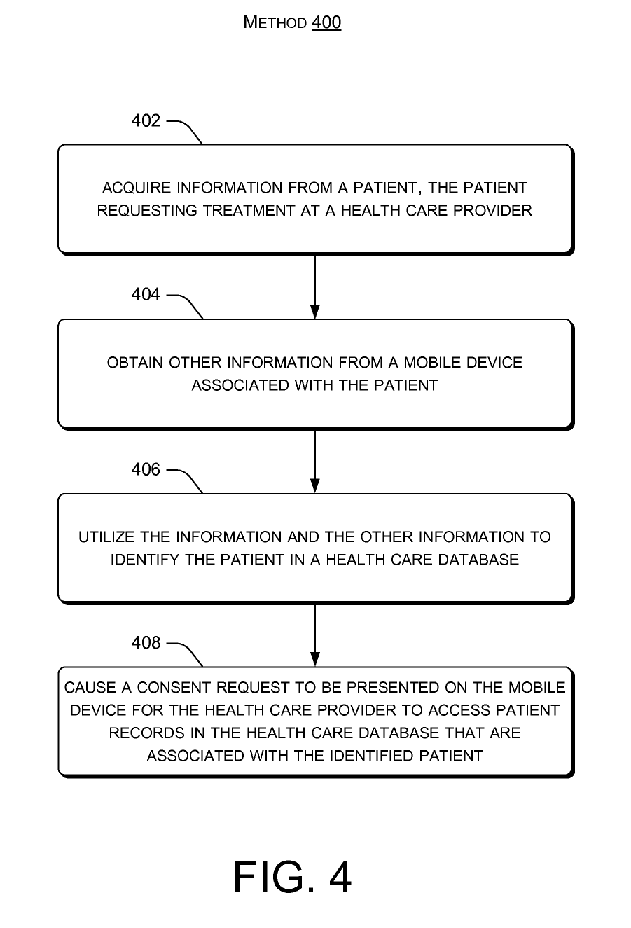

FIG. 4 illustrates a flowchart of a patient identification technique or method 400.

At block 402, the method can acquire information from a patient, the patient requesting treatment at a health care provider. For instance, the acquired information might include one or more of patient name, age, social security number, telephone number, etc.

At block 404, the method can obtain other information from a mobile computing device associated with the patient. The other information may include some of the information obtained from the patient or may be different information. Examples of this other information can include the patient's location (e.g., the mobile computing device's location), the patient's login name on various accounts on the mobile computing device, whether the client has a medical record application (such as an HCRM application or a personal health account application) on the mobile computing device and if so the patient name and/or patient identification on the medical record application. The information obtained the mobile computing device can also include location information.

At block 406, the method can utilize the information and the other information to identify the patient in a health care database.

At block 408, the method can cause a consent request to be generated on the mobile computing device for the health care provider to access patient records in the health care database that are associated with the identified patient.

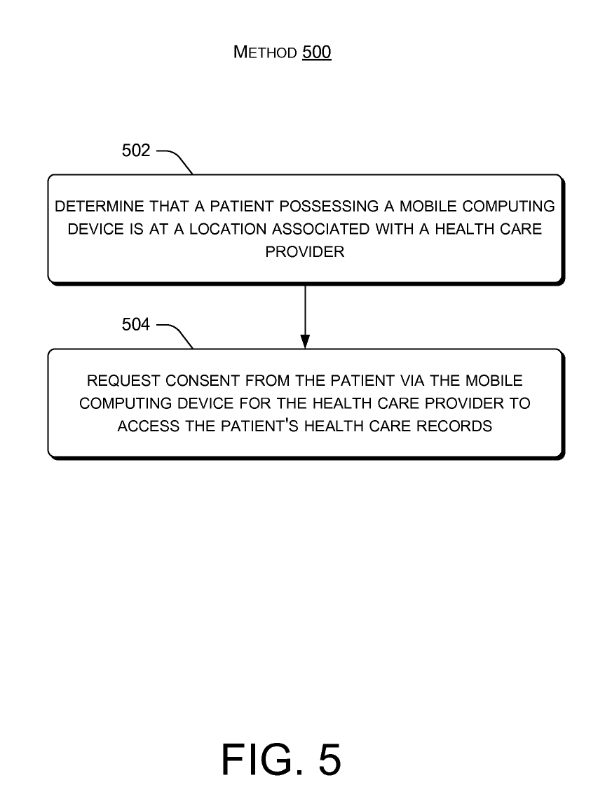

FIG. 5 illustrates a flowchart of a patient identification technique or method 500.

At block 502, the method can determine that a patient possessing a mobile computing device is at a location associated with a health care provider.

At block 504, the method can request consent from the patient via the mobile computing device for the health care provider to access the patient's health care records.

The order in which the example methods are described is not intended to be construed as a limitation, and any number of the described blocks or steps can be combined in any order to implement the methods, or alternate methods. Furthermore, the methods can be implemented in any suitable hardware, software, firmware, or combination thereof, such that a computing device can implement the method. In one case, the method is stored on one or more computer-readable storage media as a set of instructions such that execution by a computing device causes the computing device to perform the method.

### CONCLUSION

Although techniques, methods, devices, systems, etc., pertaining to patient identification and consent are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. At least one computer-readable storage medium having instructions stored thereon that, when executed by a computing device, cause the computing device to perform acts, comprising:
acquiring information from a patient, the patient requesting treatment at a health care provider;
obtaining other information including location information from a mobile computing device associated with the patient;
utilizing the information and the other information to identify the patient in a health care database and to associate a location of the patient with a location of the health care provider; and,
causing a consent request to be presented on the mobile computing device for the health care provider to access patient records in the health care database that are associated with the identified patient.

2. The computer-readable storage medium of claim 1, wherein the obtaining other information including location information comprises determining the location of the patient via an internet IP address or GPS coordinates.

3. The computer-readable storage medium of claim 1, wherein the obtaining other information comprises identifying accounts that the patient is signed onto via the mobile computing device.

4. The computer-readable storage medium of claim 3, wherein the utilizing comprises comparing a patient name included in the information to an account name of the identified accounts.

5. The computer-readable storage medium of claim 1, wherein the comparing comprises mapping the location of the patient to the location of the health care provider from a set of health care locations.

6. The computer-readable storage medium of claim 1, wherein at least one of the acquiring, the obtaining, the utilizing, and the causing are performed by the mobile computing device.

7. The computer-readable storage medium of claim 1, wherein the acquiring, the obtaining, the utilizing, and the causing are performed by a computer that is remote from the mobile computing device.

8. At least one computer-readable storage medium having instructions stored thereon that, when executed by a computing device, cause the computing device to perform acts, comprising:
detecting a presence of a patient at a health care facility, the patient possessing a mobile computing device; and,
utilizing the mobile computing device to obtain consent from the patient for the health care facility to access health care records of the patient.

9. The computer-readable storage medium of claim 8, wherein the detecting comprises detecting a physical presence of the patient at the health care facility by obtaining location information from the mobile computing device.

10. The computer-readable storage medium of claim 9, further comprising correlating the location information from the mobile computing device with a location of an individual health care facility.

11. The computer-readable storage medium of claim 8, wherein the detecting is accomplished via entering the patient into a patient information database of the health care facility or wherein the detecting is accomplished via the patient accessing a health care record management service.

12. The computer-readable storage medium of claim 11, wherein the health care record management service includes a personal health account for the patient that includes the patient's health care records.

13. The computer-readable storage medium of claim 12, further comprising causing a notification to be provided to the patient that a copy of patient records generated by the health care facility as a result of the patient's presence will be supplied to the personal health account for the patient.

14. The computer-readable storage medium of claim 8, wherein the utilizing comprises causing an electronic consent request to be presented to the patient on the mobile computing device.

15. The computer-readable storage medium of claim 8, wherein the detecting is performed automatically by a health care record management application running on the mobile computing device.

16. The computer-readable storage medium of claim 15, wherein the health care record management application automatically maps a location of the mobile computing device to a list of locations of health care facilities.

17. A computer-readable storage medium, comprising:
determining that a patient possessing a mobile computing device is at a location associated with a health care provider; and,
requesting consent from the patient via the mobile computing device for the health care provider to access the patient's health care records.

18. The computer-readable storage medium of claim 17, wherein the determining comprises the patient checking-in for care at the location and providing a telephone number of the mobile computing device as part of the checking-in and wherein the requesting comprises sending a text message to the mobile computing device.

19. The computer-readable storage medium of claim 17, wherein the determining is achieved by the patient interacting, via the mobile computing device, with a health care record management service that manages the patient's health care records.

20. The computer-readable storage medium of claim 19, wherein the interacting comprises the patient launching an application that allows the patient to access a personal health account belonging to the patient, the personal health account including a copy of the patient's health care records.
